(19) United States
(12) Patent Application Publication
(10) Pub. No.: US 2012/0171648 A1
(43) Pub. Date: Jul. 5, 2012

(54) SYSTEM FOR INCREASING THE PROBABILITY OF SUCCESS AND IDENTIFYING REQUIRED PREPARATION FOR SERVICE IN LIFESTYLE OCCUPATIONS

(76) Inventor: Paula Price, Tulsa, OK (US)

(21) Appl. No.: 12/980,918

(22) Filed: Dec. 29, 2010

(51) Int. Cl. G09B 19/00

(52) U.S. Cl. 434/219

(57) ABSTRACT

A system for electronically assessing an individual's likelihood of success within a life-style occupation, including a success defining archetype, a multi-layered questions including evaluation of a test subject, a bracketed scoring scheme indexed to different levels of success within a life-style occupation, a readiness assessment, and a process for refining the evaluation. The archetype is a representation of a successful and well documented practitioner of the life-style occupation. The evaluation serves to determine the functional equivalency between an archetype and a test subject. The evaluation is refined to yield increasingly accurate predictions of success within a life-style occupation.

### TECHNICAL FIELD

The claimed technology relates generally to the field of human resource assessment. In particular, the present novel technology relates to a method and system for the prediction of success for and the preparation of an individual for service in a lifestyle occupation.

### BACKGROUND

Determining the capacity and insufficiencies of an individual for success in a particular undertaking is a fundamental question. Hiring and training individuals is often immensely expensive in terms of money, time, and resource allocation. The commitment of hiring someone is too costly to undertake without some sort of prediction of the likelihood of a successful outcome. Likewise, the personal commitment required of an individual when choosing a profession or employment is over more costly to leave the potential for success to random chance. In essence, the problem is one of predicting the potential for success and of identifying and highlighting curable insufficiencies.

Over time, there have been many attempts to provide such a mechanism for the prediction of success. Even the classic job interview can be viewed as such a device. In the classic job interview scenario, both parties are trying to gauge the potential for success in a particular job. Other classic means of gauging the likelihood of success include predictive modeling, personality assessment, job skills testing, cognitive aptitude testing, and the like.

Job skills testing, cognitive aptitude testing, personality assessment, and most forms of predictive testing employ some form of standardized and linearly scored test. For example, general cognitive aptitude testing will test a pool of candidates on selected abilities previously found to be associated with success in a given undertaking. The candidate who scores the highest in these abilities is considered to be the one with the best chance of success at that given undertaking. Job skills testing is similar to cognitive aptitude testing with the exception that the job skills test focuses upon predetermined, job-specific abilities. As with the cognitive aptitude testing, the candidate who scores the highest in the job-specific abilities is considered to be the candidate with the best likelihood of success. Personality assessment functions much the same as the previous two prediction methods. The only substantive difference is that personality assessment focuses on the examination of the personality features of the candidate(s). The candidate whose personality contains features most closely matching personality features previously identified with high performance of a particular job or set of tasks is considered the most likely candidate to succeed at said job.

Predictive modeling is different from the linear score methods in that it utilizes a particular set of rules. The rules are derived from a correlation analysis between existing successful individuals and their level of success as compared to their various combinations of attributes. The rules are then applied to candidates and their resulting scores are compared to the scores of the originally identified successful individuals. This comparison frequently takes the form of a scatter plot.

Whatever form an assessment test takes, all success-prediction tests generally share certain inherent inadequacies. To begin with, the previously discussed success prediction tests all make use of idealized models. Job skills testing, cognitive aptitude testing, and personality assessment all rely on highly idealized models. These models may have little in common with those individuals who have actually succeeded in the tested for position in the past. Even predictive modeling makes use of a highly idealized model when testing for potential of success. In the case of predictive modeling, the model is derived from a correlation analysis between existing successful individuals and their subjectively measured level of success, as compared to their various combinations of attributes. Even under the best of conditions, the derived models represent a composite of individual and non-interactive characteristics defining an abstraction that may have little in common with those that have actually succeeded.

One flaw in these models is that the question being answered is, “how well does a candidate compare to a model believed to embody success enabling characteristics,” and thus the characteristics identified in the model tend to be subjectively identified and weighted (if at all), with no qualified derivation thereof and no possibility of taking into account complex interactions. In other words, these tests compare real people against an oversimplified composite person made up of artificially weighted and non-interacting personality traits that may not function together in a real person.

Someone succeeding against all odds is a common theme in history and literature. In such ‘against all odds’ success stories perhaps it isn't that the person should have failed. Instead, it may be that the model implicitly used to evaluate the chance of success does not accurately represent what makes success possible. In short, models do not succeed or fail; people do, and therein lies the problem. The success prediction tests score candidates against idealized and inherently oversimplified and subjective models instead of against actual successful people.

Another flaw inherent in somewhat similar idealized models is that a successful professional need not rank near the top in all of his success enabling attributes. However, those candidates who do rank near the top in their success enabling attributes tend to score better than those that do not. Often called the linear scoring effect, this flaw serves to assign a greater likelihood of success to candidates with more in common with the testing model even though they there may be no actual enhanced likelihood of success.

Another flaw in the existing technology is that there is no innate means of refinement of the success prediction tests. An individual's success or failure may ultimately have nothing in common with the model he was originally scored against. As such, it is not clear how to refine and revise a model in response to a previous tested individual's actual success or failure. Furthermore, the environment in which these tests are used make gathering past test performance information unlikely.

Another flaw in the existing success prediction test technologies is that success is represented as a binary situation, i.e., one either succeeds or fails. That is, in the existing technologies, there is no notion of succeeding at a lower level, an intermediate level, and an advanced level.

Thus, there is a need for an improved system of predicting the likelihood of success in a given job, especially if that job relates to a career of calling. The present novel technology addresses this need.

### SUMMARY

The claimed novel technology is set forth in the claims below, and the following is not in any way to limit, define or otherwise establish the scope of legal protection. In general terms, the claimed novel technology relates to a system and method of estimating the likelihood of an individual's occupational success.

One object of the novel technology is to provide an improved system for providing an estimate of a candidate's likelihood for success within life-encompassing field of occupation. Further objects, embodiments, forms, benefits, aspects, features and advantages of the claimed technology may be obtained from the description, drawings, and claims provided herein.

### BRIEF DESCRIPTION OF THE DRAWINGS

FIG. 1 is a process flow diagram for one implementation illustrating the stages involved estimating the likelihood of a person's success within a specific lifestyle occupation

FIG. 2 is a process flow diagram for one implementation illustrating the stages involved in creating an archetype.

FIG. 3 is a process flow diagram for one implementation illustrating the stages involved in refining the likelihood of success predicting questionnaire.

FIG. 4 is a diagrammatic view of a computer system of one implementation.

FIG. 5 is a process flow diagram for one implementation illustrating the stages involved in producing the readiness assessment.

FIG. 6 is a representation of the typical view of output presented to a user.

FIG. 7 is a process flow diagram for one implementation illustrating the stages involved in producing a personalized readiness improvement action plan.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

The present novel technology provides a system and method for the estimation of the likelihood of an individual's success within a life-encompassing occupation or calling. Most occupations do not require or utilize the full existence of an individual. As an example, an attorney occasionally gets to go home, gets the rare moment to relax, and has some downtime. However, some occupations so swallow up the entirety of the employed person's life that they amount to a calling or lifestyle occupation. A lifestyle occupation requires the full devotion of a person's life and being. In other words, the job is their life and accordingly the person lives the job. Examples of lifestyle occupations include the clergy, general ministerial service, specialized ministerial service, spiritual prophetic service, ministerial, apostolic positions, lifetime military career, and the like.

The present novel technology provides a mechanism for the estimation of the likelihood of an individual's success within a life-encompassing occupation at varying levels of authority. Lifestyle occupations typically have multiple senior positions that have varying levels of authority. These multiple senior positions that have varying levels of authority structure are different from the seniority and authority structure common in most occupations. For example, Attorney position levels within a law firm start with first year associate and end in senior or ‘name’ partnership. Physician position levels within a hospital start with intern or resident physician and end in hospital chief of staff. Bank positions start with teller and end in bank president. In each of these examples, the progression is based upon experience or seniority and directly corresponds with authority. But lifestyle occupations do not typically have the same correlation between seniority or skill and authority. A priest is a familiar example of a lifestyle occupation's non-correlation between seniority or skill and authority. While a priest is often thought of as the entry point into service of the church, it can also serve as a senior level position. But a senior priest has far less authority than a bishop, another senior level position that may be occupied by one having far less seniority and experience.

The present novel technology also indicates what areas of the test subject need to be improved to increase the test subject's likelihood of success within the specified lifestyle occupation. Choosing a lifestyle occupation is a huge commitment. The choice is often marked by years of consideration followed by years of training and mentoring.

Failing in a lifestyle occupation is exceptionally costly, both in time spent, in impact upon the failing individual, and in impact upon the institution itself. Additionally, it may take years for the individual to fail, which presents its own additional costs such as decreased opportunity for the individual to recover, shortened time span for cost recovery, underservice of the community by the organization, decreased opportunity for the organization to fill the position with a better suited candidate, and the like.

The present novel technology also provides a means to construct a representation of well documented individual that was successful within a lifestyle occupation. More than a model, the representation of the individual serves as an archetype. An archetype represents the person as a whole rather than just a collection of skills or personality traits.

For example, an archetype representation, while including skills and personality traits, also includes character aspects, life changing events, influential friends and family, differences with the then existing moral and ethical belief systems, and the like. An archetype serves to paint the fullest expression or representation of the successful person. In essence, an archetype representation enables a more complete understanding of what made the actual person succeed, what caused him trouble, and how he overcame difficulties to enable success. Also, an archetype not only answers how he succeeded but why he wanted to succeed, and what kept him motivated where others gave up. Probably the closest parallel to an archetype representation is a well developed FBI-style profile.

Additionally, this novel technology also provides a means to improve the accuracy of its predictions. Previous test subjects are tracked and periodically reviewed and retested. Tracking and retesting provides an ever larger pool of data used to refine the performance of the testing methodology.

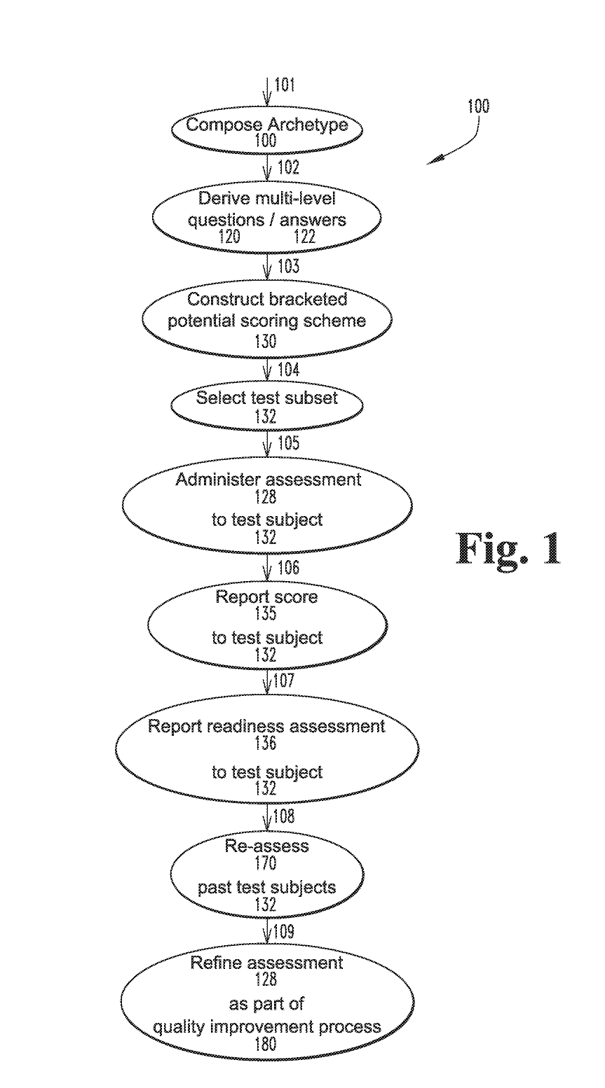

FIG. 1 is a process flow diagram 100 for one implementation illustrating the stages involved in estimating the likelihood of a person's success within a lifestyle occupation 105.

Typically, at least one archetype 110 is composed to represent the pinnacle of success within a given lifestyle occupation. Where more than one archetype 110 is composed, the multiple archetypes 110 represent the pinnacle of success for various levels of authority or specialization within the lifestyle occupation. Typically, multi-level questions 120 and answers 122 are derived from the archetype 110. In one embodiment, the life impacting childhood events of the archetype 110 may be reviewed for the effect they had on the archetype 110. These life impacting childhood events would typically then be categorized for immediacy and longevity of their effects. Typically, the life impacting childhood events would also be categorized based upon how the effects of these childhood events were expressed by the archetype 110 or what coping mechanisms the archetype 110 developed in response to the events. Similar other possible means of generating the same responses or coping mechanisms in the archetype 110 would then typically be determined. Questions would typically then be constructed that are intended to elicit whether the test subject 132 possessed similar coping mechanism and/or had experienced similar events.

However, other forms of assessment 128 may be derived from the archetype 110. Examples of the other forms or additional means of assessment 128 include a review of past activities and accomplishments, interviewing friends and family, stress response measurement, challenge-response evaluation, and the like. A stress response measurement is a test where the subject's response to a stressful situation is measured. A challenge-response evaluation is a test where the subject's ability to rise to the challenge of and overcome a complex situation is evaluated.

Because the archetype 110 is typically an encompassing view of an individual, the multi-level questions 120 are not limited to any single aspect or characterization. For example, the multi-level questions 120 can be over skill sets, personality traits, habits, childhood experiences, relationship experiences, and the like.

The multi-level questions 120 and corresponding multi-level answers 122 are typically multi-level in the sense that they represent multiple different informative aspects at the same time. For example, a question 120 about regular athletic activities may reveal experience with team activities, organizational capabilities, physical fitness, attitudes towards group activities, aggressiveness, and the like. A corresponding multi-level answer 122 is similarly informative. Additionally, a scoring or weighting factor is also typically associated to each of the levels (informations) of the multi-level questions 120 and multi-level answers 122. The different areas of information associated with multi-level questions and multi-level answers are typically known as labels 126.

It is instructive to note that while the typical embodiment of the novel technology makes use of multi-level questions 120 and multi-level answers 122, other possible means of assessment 128 may also be derived from the archetype 110. For example, physical fitness, musical ability, athleticism, stress tolerance, friendliness, attractiveness, and the like may be archetype 110 derived assessments 128 not immediately expressible as multi-level questions 120 and multi-level answers 122.

Bracketed score groups 130 are then typically constructed producing a bracketed potential success scoring scheme 130. As elsewhere discussed, lifestyle occupations are unusual in that they do not necessarily have the occupational progression associated with authority progression. The bracketed score groups 130 usually represent the likelihood of success at graduated levels of authority within the lifestyle occupation.

A subject 132 desiring to enter into the lifestyle occupation is selected. An assessment 128 is then administered to the subject 132. In one embodiment, the assessment 128 takes the form of a questionnaire 129 consisting of the multi-level questions 120 and answers 122. The assessment 128 is administered 140 to this subject 132. The subject's score 135 is typically reported 150 to him. Typically, a readiness assessment 136, listing areas of inadequacy 137 is also reported to him. Other embodiments have the readiness assessment 136 also being reported to a readiness tutor. The readiness assessment 136 of other implementations also typically includes a highly personalized, step by step of readiness enhancement program 138.

One way to view the readiness assessment 136 is to see it as a list of failure promoting insufficiencies. Another embodiment has the subject 132 being someone who has already achieved success at a certain level within the lifestyle occupation. This already successful subject's score 135 is then typically used to refine the questionnaire 129 as part of the quality improvement process 180.

Periodically, past test subjects are typically re-assessed 170. The resulting re-assessment scores along with past subjects' success 132 within the lifestyle occupation are used to refine the assessment 136 as part of the quality improvement process 180. Occasionally, the quality improvement process 180 may lead to a refinement of the archetype 110.

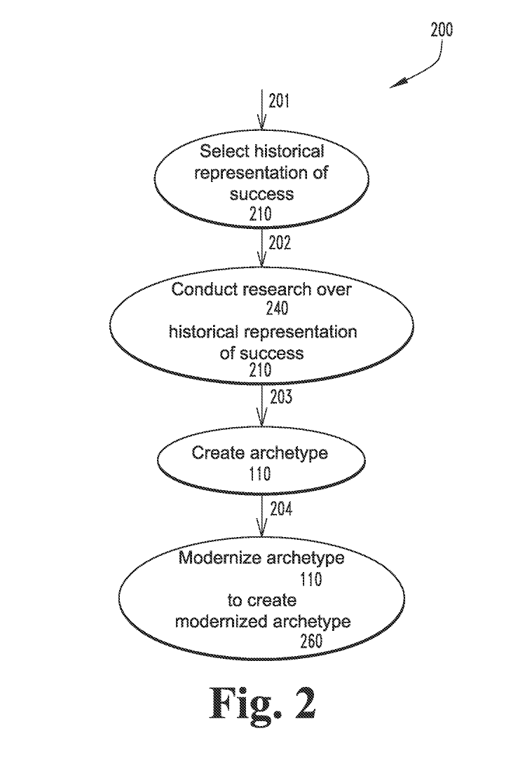

FIG. 2 is a process flow diagram 200 for one implementation illustrating the stages involved in creating an archetype 110. Historical representatives of success 210 within the lifestyle occupation 105 are chosen 220. Additionally, these representatives of success 210 are usually also historically significant, as this significance tends to increase the amount of available historical references.

Research is then conducted 240 to create as complete of a full description of the historical representatives 210 as possible. This full description is then typically used along with various psychological analyses, period reconstruction of beliefs and norms, reconstruction tools, and the like to create a dated archetype 110. Typically, the final step is to take the dated archetype 110 and to modernize it into a modernized archetype 260.

Modernization is the process where a dated archetype 110 is adjusted to account for modern day influences, norms, expectations, experiences, traits, and the like.

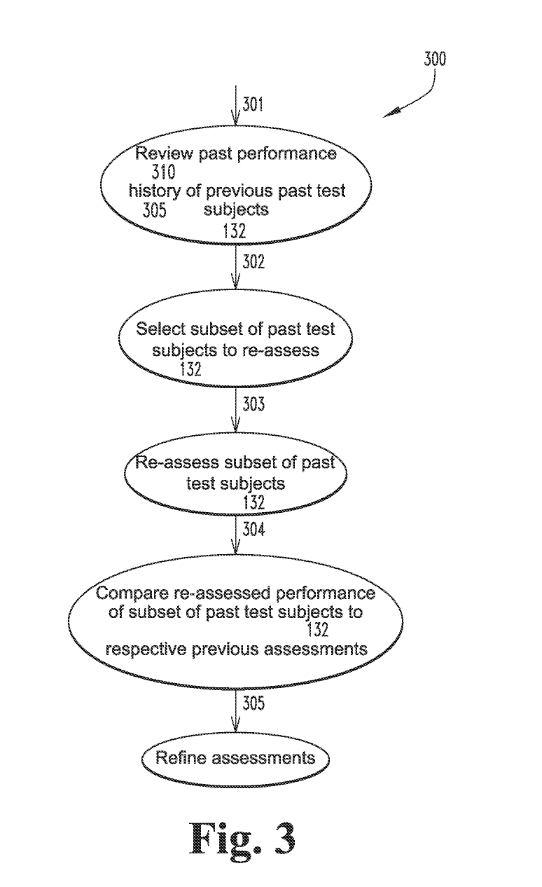

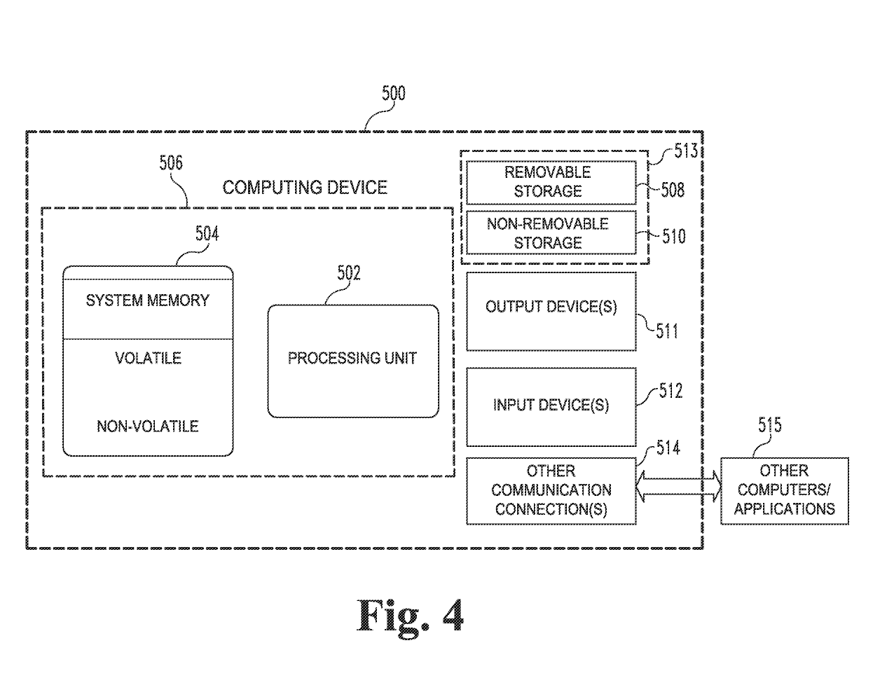

FIG. 3 is a process flow diagram for one implementation illustrating the stages involved in refining the likelihood of success predicting questionnaire 129. Typically, the performance history 305 of previous test subjects 132 is reviewed 310. Unlike more conventional occupations, lifestyle occupations tend to remain within the same field and often with the same employer. Staying within the same field and with the same employer makes the periodic contact with these past test subjects 132, used to acquire their occupational success, easier.

If the lifestyle occupational success of previous test 132 subjects varies sufficiently from their predicted success, then the previous test subjects 132 are contacted and asked to take the current form of the questionnaire 129. Original and new questionnaire 129 performances are compared as well as both predicted levels of success 315 along with actual success 315. Differences between the original and subsequent test results are analyzed to determined what questions 120 and answers 125 need to be improved and/or have their weights (scores) revalued. Multi-level questions 120 and multi-level answers 125 overly dissimilar between the past and present versions of the test 132 are typically either unified into a common multi-level question 120 or turned into non-overlapping multi-level questions 120 and multi-level answers 125.

Weights and scores for the multi-level questions and answers are then typically adjusted, reflecting any alterations in the questionnaire 129 and to more closely add up to the score representative of the subject's actual performance.

FIG. 4 is a diagrammatic view of a computer system 500 of one implementation. As shown in FIG. 4, an exemplary computer system to use for implementing one or more parts of the computer system 500 includes a computing device 501. In its most basic configuration, computing device 501 typically includes at least one processing unit 502 and at least one memory unit 504. Depending on the exact configuration and type of computing device, memory unit 504 may be volatile (such as RAM), non-volatile (such as ROM, flash memory, etc.) or some combination of the two. This most basic configuration 506 is illustrated in FIG. 4.

Additionally, computing device 501 may also have additional features and/or functionality. For example, computing device 501 may also include additional data storage 513 (removable and/or non-removable) including, but not limited to, magnetic or optical disks or tape. Such additional storage is illustrated in FIG. 4 by removable storage 508 and non-removable storage 510. Computer storage media includes volatile and nonvolatile, removable and non-removable media implemented in any method or technology for storage of information such as computer readable instructions, data structures, program modules or other data. Memory unit 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 501. Any such computer storage media may be part of computing device 501.

Computing device 501 typically includes one or more communication connections 514 that allow computing device 501 to communicate with other computers/applications 515. Computing device 501 may also have input device(s) 512 such as keyboard, mouse, pen, voice input device, touch input device, etc. Output device(s) 511 such as a display, speakers, printer, etc. may also be included. These devices 511, 512 are well known in the art and need not be discussed at length here.

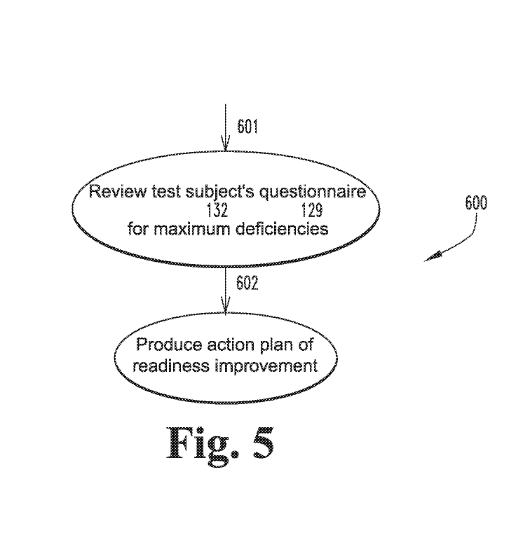

FIG. 5 is a process flow diagram for one implementation illustrating the stages involved in producing the readiness assessment 128. Lifestyle occupations 611 require an extreme level of commitment, preparation, and time. Failing in a lifestyle occupation 611 may take years, is frequently highly destructive to the individual, and may even leave that individual eventually devastated and/or financially destitute. Because of the long delay and costly impact upon an individual should he fail in a lifestyle occupation 611, it is wise to utilize every possible means of enhancing the likelihood of success. Typically, a test subject 132 taking the questionnaire 129 is given both a likelihood of success within the lifestyle occupation 611 and a readiness assessment 128. The readiness assessment 128 usually indicates in what areas the test subject 132 needs to improve to increase his likelihood of success within the lifestyle occupation 611.

The test subject's questionnaire 129 is examined yielding a list 610 of the questions 120 on which the test subject 132 performed poorly. The list 610 is then ordered 620, typically with the questions organized or arranged in order of their potential maximum impact upon the test subject's questionnaire performance. A list of areas, knowledges, actions, activities, and the like is then produced from the list of answers 122 that would have yielded the maximum questionnaire impact 630. The list of areas, know ledges, actions, activities, and the like, along with a personalized explanation, is then presented to the test subject 132.

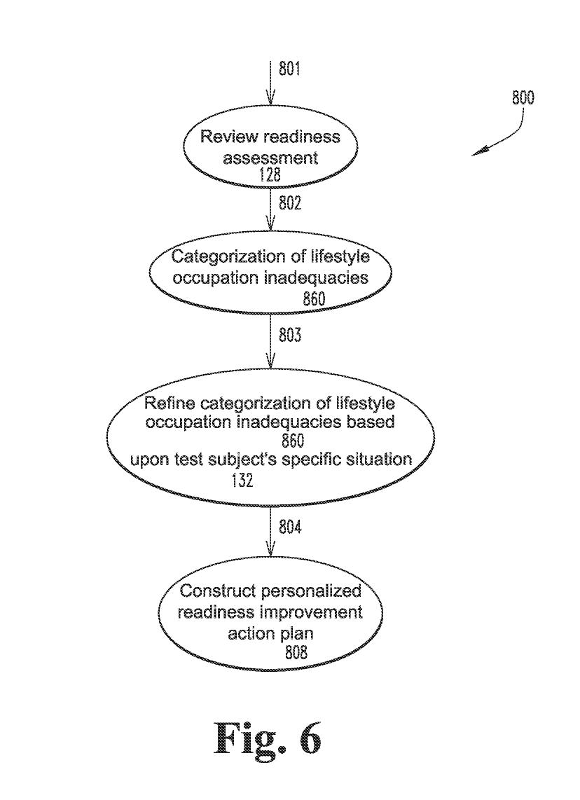

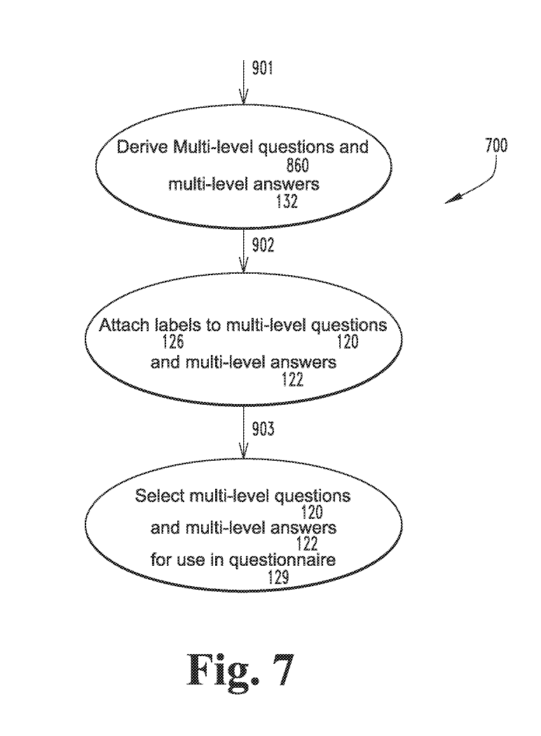

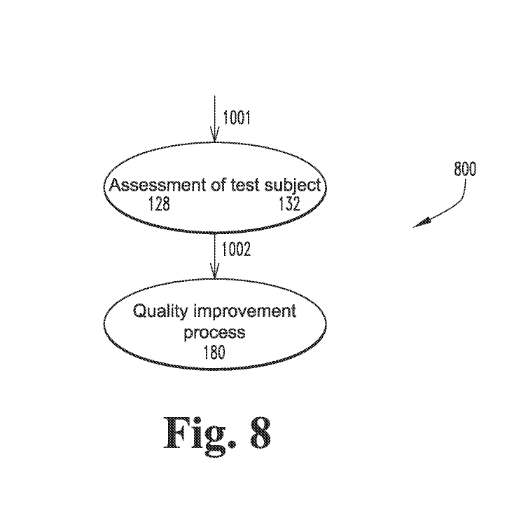

FIG. 6 is a process flow diagram 805 for one implementation illustrating the stages involved in producing a personalized readiness improvement action plan 808, also known as a personalized readiness enhancement program 808. Because lifestyle occupations 611 encompass such a large portion of the test subject's 132 life, lifestyle occupation 611 inadequacies are often not just a lack of knowledge. Lifestyle occupation inadequacies 860 often can include missing personality traits, experiences, philosophies, abilities, beliefs, and the like. Correcting a lifestyle occupation inadequacy 860 often requires an extensive and personal effort.

The test subject's readiness assessment 128 is reviewed 810. Typically, the subject's lifestyle occupation inadequacies 860 are categorized 820, such as based upon their severity and complexity of correction. The categorization 820 of the subject's lifestyle occupation inadequacies 860 is further refined 830 based upon the subject's specific situation. For example, a subject's specific personality or philosophy may adversely impact the ease with which a lifestyle occupation inadequacy may be corrected. A personalized readiness improvement action plan 808 is constructed 840 for the subject from the refined lifestyle occupational inadequacies. Typically, the personalized readiness improvement plan 808 includes both personal and employment milestones, frequent interaction with readiness coaches, exercises, training and educational materials, periodic reviews and retesting, and the like.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A system for electronically assessing an individual's likelihood of success and identifying areas in need of improvement in a chosen occupation, comprising:
an archetype defining success in a particular occupation;
an evaluation that includes a questionnaire consisting of multi-layered questions and multi-layered answer choices;
a bracketed scoring scheme for determining likelihood of success;
a readiness assessment; and
a quality improvement process;
wherein the archetype is a representation of a well documented practitioner of the occupation;
wherein the multi-layered questions are derived from the archetype;
wherein the multi-layered answers are derived from the archetype;
wherein the readiness assessment is derived from the test subject's performance on the questionnaire;
wherein the quality improvement process refines the multi-layered questions; and
wherein the quality improvement process refines the multi-layered answers.

2. The system of claim 1 wherein the archetype is derived through comprehensive analysis of the well documented representative of the occupational success.

3. The system of claim 1 wherein the evaluation additionally includes at least one of the activities from the group including: review of past activities and accomplishments, interviews of friends and family, induced stress response evaluation, and challenge-response evaluation.

4. The system of claim 1 wherein the readiness assessment includes a personalized readiness enhancement program.

5. The system of claim 2 wherein the archetype is modernized to translate to present day society.

6. The system of claim 1 wherein each of the multi-layered questions are assigned a respective collection of labels, each respectively corresponding to a collection of information addressed by the question.

7. The system of claim 1 wherein each of the multi-layered questions is assigned a respective collection of importance values corresponding to the importance of the question with respect to the information the question serves to address.

8. The system of claim 1 wherein the multi-layered answers are each assigned a respective collection of indicators, each of the indicators serving to denote specific information associated with the respective multi-layered answer.

9. The system of claim 1 wherein a readiness improvement action plan personalized to the test subject is derived from the readiness assessment.

10. The system of claim 1 wherein the bracketed potential success scoring scheme represents an assessed individual's likelihood for success at graduated levels of success within a chosen occupation.

11. The system of claim 1 wherein the quality improvement process refines the archetype representation through the evaluation of the suitability of past assessed individuals.

12. The system of claim 1 wherein the quality improvement process refines the multi-layered questions through the evaluation of the suitability of past assessed individuals.

13. The system of claim 1 wherein the quality improvement process refines the multi-layered answers through the evaluation of the suitability of past assessed individuals.

14. A computer-readable medium having computer-executable instructions for causing a computer to perform steps comprising:
identifying an archetype for a given life style occupation;
generating a multi-layered questionnaire to assess a test subject's similarity to the archetype;
administering the multi-layered questionnaire to the test subject to yield a set of answers;
evaluating the set of answers;
generating a notification containing a series of bracketed likelihoods for success in the lifestyle occupation;
and
generating a personalized readiness improvement.

15. The computer-readable medium of claim 13, wherein the bracketed likelihoods for success correspond to likelihoods of success for varying levels of authority within the lifestyle occupation.

16. The computer-readable medium of claim 13, wherein the outputting step is configured to display the series of bracketed likelihoods for success in the lifestyle occupation on an internet enabled browser interface.

17. The computer-readable medium of claim 13, wherein the multi-layered questionnaire is periodically refined through the evaluation of past subjects' scores and through the past subjects' success within the lifestyle occupation.

18. A method assessing a person's degree of suitability and areas in need of improvement for a particular lifestyle occupation comprising:
a. constructing at least one archetype of a well documented person within a particular occupation;
wherein the at least one archetype is a representation of suitability within a particular occupation;
b. developing multi-layered questionnaire for assessing similarity to the at least one archetype;
c. administering the multi-layered questionnaire to a person desiring to enter into the particular occupation;
d. subsequently measuring the person's performance in the particular occupation;
e. re-administering the multi-layered questionnaire to the person; and
f. refining the multi-layered questionnaire.

19. The method according to claim 17, further comprising the steps of:
g. after (b) and before (c), developing multi-layered answers to the multi-layered questionnaire;
h. developing bracketed scoring for the multi-layered questionnaire depicting suitability at different levels of authority in a lifestyle occupation.

20. The method according to claim 17, wherein the constructing of at least one archetype includes creating a representation of a person whereby a representation of the person's character traits, life changing events, influential friends, influential family members, influential enemies, likes, dislikes, and differences between the person's ethical and moral beliefs and those of his society's prevalent ethical and moral beliefs are constructed.
